(19) United States
(12) Patent Application Publication
(10) Pub. No.: US 2021/0122955 A1
(43) Pub. Date: Apr. 29, 2021

(54) POLYPROPYLENE BONDING ADHESIVE AND PROCESS

(71) Applicant: DDP SPECIALTY ELECTRONIC MATERIALS US, LLC, WILMINGTON, DE (US)

(72) Inventors: SERGIO GRUNDER, Freienbach (CH); STEFAN SCHMATLOCH, Freienbach (CH); JOEL AMOS KUNZ, Horgen (CH)

(21) Appl. No.: 17/055,629

(22) PCT Filed: Jun. 7, 2019
(86) PCT No.: PCT/US2019/036011

§ 371 Date: Nov. 16, 2020

Related U.S. Application Data
(60) Provisional application No. 62/687,492, filed on Jun. 20, 2018.

(51) Int. Cl. C09J 175/08; C08G 18/12; C08G 18/20; C08G 18/24; C08G 18/48; C08G 18/50; C08G 18/73; C08G 18/76; C08G 18/79; C08K 3/26; C08K 3/34; C08K 9/04

(52) U.S. Cl. CPC C09J 175/08; C08K 2201/006; C08G 18/2063; C08G 18/242; C08G 18/4816; C08G 18/482; C08G 18/4829; C08G 18/4841; C08G 18/4845; C08G 18/5024; C08G 18/73; C08G 18/7621; C08G 18/798; C08K 3/26; C08K 3/346; C08K 9/04; C08G 2170/00; C09J 2203/354; C09J 2301/162; C09J 2301/30; C09J 2423/106; C09J 2423/108; C09J 2475/00; C08K 2003/265; C08K 2201/005; C08G 18/12

(57) ABSTRACT

A two-part polyurethane adhesive exhibits excellent adhesion to low surface energy substrates such as polypropylene. The adhesive consists of a polyol component and a polyisocyanate component that are combined and cured to form the adhesive bond. The polyol component is characterized in containing a monoalcohol that has a molecular weight of 100 to 2000. The presence of the monoalcohol promotes strong bonding and a cohesive failure mode that is preferred in vehicular applications.

This invention relates to two-part polyurethane adhesives that are useful for polypropylene bonding.

Alternative materials are replacing steel in vehicle production and other applications. This is driven in part by a desire to minimize vehicle weight in some cases by the significant aesthetic advantages that can be obtained using alternative materials.

Polypropylene is among these alternatives. Polypropylene is an engineering plastic that can be used, for example, to make automotive fascia and trim. It is also being investigated for using in making other exterior parts such as truck tailgates. The polypropylene is usually compounded with a mineral filler such as talc or calcium carbonate to stiffen the material and reduce its overall cost. When greater rigidity is wanted, the polypropylene may be reinforced with a fiber reinforcement such as glass or carbon fibers.

It would be advantageous to use adhesives to assemble these polypropylene parts to the vehicle or other components of the vehicle. Gluing offers the opportunity for easy and flexible manufacturing as well as potentially providing asthetic benefits because mechanical fasteners can be partially or entirely eliminated.

A problem with the gluing approach is that polypropylene is a very low surface energy material to which most adhesives bond poorly. This can be alleviated somewhat through pretreating the polypropylene before the adhesive is applied. It is usually necessary to employ two different pretreatments to obtain good adhesion. The polypropylene is flame-treated or plasma-treated to increase its surface energy. This can be done quickly and inexpensively and so does not represent a significant manufacturing hurdle. The second treatment involves application of an adhesion primer before the adhesive is applied. The primer treatment is laborious, time-consuming, requires the purchase of an additional raw material, and introduces volatile compounds into the workplace.

An adhesive that bonds well to polypropylene without the need for the prior application of a primer would be greatly desired.

This invention is in one aspect a two-component polyurethane adhesive composition having a polyol component and an isocyanate component, wherein:

the polyol component comprises:

a) at least 15 weight percent, based on the weight of the polyol component, of one or more polyether polyols each having a nominal hydroxyl functionality of at least 2 and a hydroxyl equivalent weight of 400 to 2000, and each being selected from homopolymers of propylene oxide and copolymers of 70 to 99% by weight propylene oxide and 1 to 30% by weight ethylene oxide, the one or more polyether polyols a-1) having an average nominal hydroxyl functionality of 2 to 4;

b) 0 to 30 weight percent, based on the weight of the polyol component, of one or more polyether polyols each having a hydroxyl equivalent weight of 100 to 399, the one or more polyether polyols b) having an average nominal functionality of at least 4;

c) 0 to 10 weight percent, based on the weight of the polyol component, of a polyol having a hydroxyl functionality of at least 2 and a hydroxyl equivalent weight of less than 100;

d) 2 to 40 weight percent, based on the weight of the polyol component, of a monol having a molecular weight of 100 to 2000;

e) 0 to 3 parts by weight per 100 parts by weight of a) of at least one compound having at least two primary and/or secondary aliphatic amine groups;

f) a catalytically effective amount of at least one urethane catalyst; and

g) 5 to 60 weight percent, based on the weight of the polyol component, of at least one particulate filler;

and the polyisocyanate component comprises at least one organic polyisocyanate and 0 to 50% by weight, based on the total weight of the polyisocyanate component, of at least one particulate filler.

The invention is also a cured adhesive formed by combining the polyol and polyisocyanate components of the invention to form an uncured adhesive, and then curing the uncured adhesive. The invention is also a method of bonding two substrates, comprising combining the polyol and polyisocyanate components of the invention to form an uncured adhesive, forming a layer of the uncured adhesive at a bondline between two substrates, and curing the uncured adhesive layer at the bondline to form a cured adhesive bonded to each of the substrates.

The adhesive composition adheres strongly to many substrates. It exhibits excellent adhesion to plastics and to composites such as CFRP.

An important advantage of this invention is the ability of the adhesive to bond well to low energy substrates, of which polypropylene is of particular significance. The adhesive bonds strongly to polypropylene, even filled and/or reinforced polypropylene that contains mineral fillers and/or glass or other fiber reinforcement, yet fails in a cohesive failure mode that is highly desirable in vehicular applications.

Component a) of the polyol component of the adhesive is one or more polyether polyols each having a nominal hydroxyl functionality of at least 2 and a hydroxyl equivalent weight of 400 to 2000, and each being selected from homopolymers of propylene oxide and copolymers of 70 to 99% by weight propylene oxide and 1 to 30% by weight ethylene oxide.

The polyether polyol(s) within component a) each may have a nominal functionality of 2 to 4. The hydroxyl equivalent weight of each of the polyether polyol(s) that constitutes component a) in some embodiments is at least 500, at least 800 or at least 1000, and in some embodiments is up to 1800, up to 1500 or up to 1200. All hydroxyl equivalent weights herein are obtained by measuring hydroxyl number using a titration method such as that of ASTM E222 and converting the hydroxyl number so obtained (in mg KOH/gram) to equivalent weight using the formula equivalent weight=56,100±hydroxyl number.

By “nominal functionality” of a polyether polyol (or mixture thereof), it is meant the average number of oxyalkylatable hydrogen atoms on the initiator compound(s) alkoxylated to form the polyether polyol(s). The actual functionalities of the polyether polyol(s) may be somewhat lower than the nominal functionality due to side-reactions that occur during the alkoxylation process.

Component a) constitutes at least 15% of the weight of the polyol component. It may constitute at least 18%, 20%, at least 25% of the weight of the polyol component, and may constitute up to 80%, up to 65% up to 50%, up to 40% or up to 30% thereof.

In some embodiments, 50% or more of the hydroxyl groups of the hydroxyl groups of the component a) polyether polyol(s) are primary, with the remainder being secondary. 70% or more of the hydroxyl groups of component a) thereof may be primary.

Component b) of the polyol component is at least one polyether polyol having a hydroxyl equivalent weight of 100 to 399 and a nominal functionality of at least 4. The nominal functionality is preferably at least 6 and may be at least 6.5. The nominal functionality may be up to 12, up to 10 or up to 8. The equivalent weight of each of the polyether polyol(s) that constitute component b) may be, for example, at least 125 or at least 150 and may be, for example, up to 350, up to 350, up to 275 or up to 250.

Component b) of the polyol component is optional and may be omitted. Preferably, it is present in an amount of at least 2 weight percent, based on the weight of the polyol component. It may constitute at least 3 or at least 4 weight percent thereof and may constitute up to 30%, up to 20%, up to 15%, up to 10%, up to 8% or up to 6% thereof.

Components a) and b) of the polyol component each are selected from homopolymers of propylene oxide and copolymers of 70 to 99% by weight propylene oxide and 1 to 30% by weight ethylene oxide, in each case based on the combined weight of propylene oxide and ethylene oxide that are polymerized to produce such component. In the case of a copolymer, the propylene oxide and ethylene oxide may be randomly copolymerized, block copolymerized, or both.

Ingredient c) of the polyol component is one or more polyols having a hydroxyl functionality of at least 2 and a hydroxyl equivalent weight of less than 100. These include aliphatic diol chain extenders that have a hydroxyl equivalent weight of at least 25 and up to 99, preferably up to 90, more preferably up to 75 and still more preferably up to 60, and exactly two aliphatic hydroxyl groups per molecule. Examples of these are monoethylene glycol, diethylene glycol, triethylene glycol, 1,2-propane diol, 1,3-propane diol, 2,3-dimethyl-1,3-propanediol, dipropylene glycol, tripropylene glycol, 1,4-butanediol, 1,6-hexanediol and other linear or branched alkylene diols having up to about 6 carbon atoms. The aliphatic diol chain extender preferably includes monoethylene glycol, 1,4-butanediol or a mixture thereof. Also included are crosslinkers such as glycerine, trimethylolpropane, trimethylolethane, pentaerythritol, erythritol, mannitol, sucrose, sorbitol and the like and alkoxylates of any one or more of these that have hydroxyl equivalent weights less than 100.

Component c) is optional and may be omitted. If present, it may constitute as much as 10 percent of the total weight of the polyol component. Component c) may constitute, for example, at least 0.25% or at least 0.5% of the weight of the polyol component and up to, for example, 5%, up to 3% or up to 1.5% of the weight thereof.

Component d) is a one or more monols having a molecular weight of 100 to 2000. A “monol” is a compound having exactly one hydroxyl group.

The monol preferably has a molecular weight of at least 250, at least 500 or at least 700. The monol molecular weight may be up to 1750, up to 1500, up to 1200 or up to 1000.

The monol preferably is linear. By “linear”, it is meant that the monol has no side chains having more than 4, especially more than 2, carbon atoms.

The monol may contain a hydrocarbyl chain of 4 or more carbon atoms, especially of at least 10 carbon atoms. The hydrocarbyl chain may contain up to 50, up to 30 or up to 20 carbon atoms. The hydrocarbyl chain is preferably aliphatic.

The monol may contain a polyether chain. The polyether chain may be a polymer, for example, of one or more of ethylene oxide, propylene oxide, 1,2-butylene oxide, 2,3-butylene oxide or tetrahydrofuran. Polymerized ethylene oxide, if present, preferably constitutes no more than 50% of the total weight of the monol.

The monol may be one represented by the structure A-B—OH, wherein A represents a hydrocarbyl group and B represents a polyether chain, wherein the lengths of A and B are such that the monol has a molecular weight as described above. A may represent, for example, an saturated or unsaturated aliphatic group having 2 to 50 carbon atoms. The group A preferably has 4 to 30, 4 to 30 or 4 or 20 carbon atoms. In some embodiments, A is a C4-20 straight-chain aliphatic hydrocarbyl group that may be saturated or unsaturated, but is preferably saturated. “Hydrocarbyl” denotes a molecule or group, as the case may be, that contains only carbon and hydrogen atoms.

The group B may be a polymer, for example, of one or more of ethylene oxide, propylene oxide, 1,2-butylene oxide, 2,3-butylene oxide or tetrahydrofuran. Polymerized ethylene oxide, if present, preferably constitutes no more than 50% of the total weight of the group B. The group B may have a weight of, for example, 100 to 1900 atomic mass units. In particular embodiments, it has a weight of at least 300 or at least 500, up to 1500, up to 1200 or up to 1000.

Monols having the structure A-B—OH can be prepared by alkoxylating a monoalcohol having the form A-OH, where A is as before.

Component d) constitutes 2 to 40 percent of the total weight of the polyol component. Component d) may constitute, for example, at least 3%, at least 4% or at least 5% of the weight of the polyol component and up to, for example, 30%, up to 20% or up to 15% of the weight thereof.

Ingredient e) of the polyol component is at least one compound having two or more primary and/or secondary aliphatic amine groups. Ingredient e) is optional and may be omitted. Such compounds preferably have a molecular weight of at least 60, more preferably at least 100, up to 1000, more preferably up to about 750 and still more preferably up to 500. Such compounds may have 2 to 4, more preferably 2 to 3, primary and/or second aliphatic amine groups and 2 to 8, more preferably 3 to 6 hydrogens bonded to aliphatic nitrogen atoms. Examples of the ingredient e) materials include ethylene diamine; 1,3-propanediamine; 1,2-propanediamine; polyalkylene polyamines such as diethylene triamine and triethylene tetraamine; isophorone diamine; cyclohexane diamine; bis(aminomethyl)cyclohexane; and aminated polyethers such as those sold as Jeffamine™ D-400 and T-403 by Huntsman Corporation. The ingredient e) material, when present, provides a rapid initial thickening when the polyol and polyisocyanate components are first mixed, but is present in only a small amount so open time remains long enough that the adhesive can be mixed and applied in an industrial setting. The ingredient e) material therefore is present (if present at all) in an amount of 0.1 to 3 parts by weight per 100 parts by weight of ingredient a), and in some embodiments 0.25 to 2 parts by weight or 0.5 to 1.5 parts by weight on the same basis.

The polyol component further contains ingredient f), a catalytically effective amount of at least one urethane catalyst. A “urethane catalyst” for purposes of this invention is a material that catalyzes the reaction of a hydroxyl group with an isocyanate group. Suitable catalysts include, for example, tertiary amines, cyclic amidines, tertiary phosphines, various metal chelates, acid metal salts, strong bases, various metal alcoholates and phenolates and metal salts of organic acids.

The catalyst may be or include one or more tin catalysts such as stannic chloride, stannous chloride, stannous octoate, stannous oleate, dimethyltin dilaurate, dibutyltin dilaurate, tin ricinoleate and other tin compounds of the formula SnRₙ(OR)₄₋ₙ, wherein R is alkyl or aryl and n is 0 to 18, and the like. Other useful tin catalysts include dialkyltin mercaptides such as dioctyltinmercaptide and dibutyltinmercaptide and dialkyltin thioglycolates such as dioctyltin thioglycolate and dibutyltin thioglycolate. Dialkyltin mercaptides and dialkyltin thioglycolates having at least 4 carbons in the alkyl groups tend to provide a beneficial degree of latency, which is believed to contribute to both the long open time and the rapid development of properties upon ambient temperature cure.

Examples of other metal-containing catalysts are bismuth, cobalt and zinc salts.

Examples of tertiary amine catalysts include trimethylamine, triethylamine, N-methylmorpholine, N-ethylmorpholine, N,N-dimethylbenzylamine, N, N-dimethylethanolamine, N,N,N′,N′-tetramethyl-1, 4-butanediamine, N, N-dimethylpiperazine, 1, 4-diazobicyclo-2, 2,2-octane, bis(dimethylaminoethyl)ether, triethylenediamine and dimethylalkylamines where the alkyl group contains from 4 to 18 carbon atoms. Useful amidine catalysts include 1,8-diazabicyclo[5.4.0]-undec-7-ene.

In some embodiments, the urethane catalyst includes at least one latent catalyst. For purposes of this invention, a latent catalyst is one which requires exposure to an elevated temperature of at least 40° C. to become catalytically active. (Note that this temperature can be generated during curing by the heat of exotherm of the adhesive during initial stages of cure.) Examples of such latent catalysts include, for example, dialkyltin thioglycolates such as dioctyltin thioglycolate and dibutyltin thioglycolate; carboxylic acid-blocked tertiary amine and/or cyclic amidine catalysts, in which the acid blocking group is, for example, a carboxylic acid such as a C1-C18 alkanoic acid, a benzoate or substituted benzoate and the like; and phenol-blocked tertiary amine and/or cyclic amidine catalsyts. Any of the tertiary amine and/or cyclic amidine catalysts described above can be acid-blocked or phenol-blocked in this manner to produce a latent catalyst. Specific examples include carboxylic acid-blocked triethylene diamine catalysts such as Niax™ 537 (Momentive Performance Products) and carboxylic acid-blocked 1,8-diazabicyclo[5.4.0]-undec-7-ene catalysts such as Toyocat DB41 (Tosoh Corporation) and Polycat SA-1/10 (Momentive Performance Products). An example of a phenol-blocked amidine catalyst is a phenol-blocked 1,8-diazabicyclo[5.4.0]-undec-7-ene such as Toyocat DB60 (Tosoh Corporation).

In still other embodiments, the catalyst (component f)) includes at least one catalyst selected from dibutyltin mercaptide, dioctyl tin mercaptide, dibutyltin thioglycolate and dioctyltin thioglycolate and at least one carboxylic acid- or phenol-blocked cyclic amidine catalyst. In particular embodiments, the catalyst (component f)) includes dibutyltin thioglycolate and/or dioctyltin thioglycolate and at least one carboxylic acid- or phenol blocked 1,8-diazabicyclo[5.4.0]-undec-7-ene. In other particular embodiments, the catalyst (component f)) includes dibutyltin thioglycolate and/or dioctyltin thioglycolate, at least one carboxylic acid-blocked cyclic amidine (such as 1,8-diazabicyclo[5.4.0]-undec-7-ene) and at least one phenol-blocked cyclic amidine (such as 1,8-diazabicyclo[5.4.0]-undec-7-ene). In any of the foregoing embodiments, the catalyst may exclude any catalysts other than those specifically mentioned.

The catalyst(s) are used in catalytically effective amounts, each catalyst being employed, for example, in an amount from about 0.0015 to about 5% of the total weight of the polyol component. A preferred amount is up to 0.5% or up to 0.25% on the same basis.

The polyol component contains 5 to 60 weight percent, based on the weight of the polyol component, of at least one particulate filler g). The particulate filler may constitute, for example, 10 to 60, 25 to 60, or 30 to 55 weight percent of the polyol component.

The particulate filler particles are of a solid material at room temperature, are not soluble in the other ingredients of the polyol component or in the polyisocyanate component or any ingredient thereof and do not melt, volatilize or degrade under the conditions of the curing reaction between the polyol and polyisocyanate components. The filler particles may be, for example, an inorganic material such as glass, silica, boron oxide, boron nitride, titanium oxide, titanium nitride, fly ash, ground (but not precipitated) calcium carbonate, precipitated calcium carbonate, various alumina-silicates including clays such as wollastonite and kaolin, metal particles such as iron, titanium, aluminum, copper, brass, bronze and the like, thermoset polymer particles such as polyurethane, cured epoxy resin, phenol-formaldehyde, cresol-formaldehyde, crosslinked polystyrene and the like, thermoplastics such as polystyrene, styrene-acrylonitrile copolymers, polyimide, polyamide-imide, polyether ketone, polyether-ether ketone, polyethyleneimine, poly(p-phenylene sulfide), polyoxymethylene, polycarbonate and the like; and various types of carbon such as activated carbon, graphite, carbon black and the like. The filler particles in some embodiments have an aspect ratio of up to 5, preferably up to 2, more preferably up to 1.5.

Some or all of the filler particles, if present, can be grafted onto one or more of the polyether polyol(s) that constitute ingredient (a) of the polyol component.

In a preferred embodiment, the filler particles include precipitated calcium carbonate filler particles having a particle size of up to 200 nm. The particle size may be, for example, from 10 to 200 nm, from 15 to 205 nm or from 25 to 200 nm. Particle sizes are conveniently measured using dynamic light scattering methods, or laser diffraction methods for particles having a size below about 100 nm. “Precipitated” calcium carbonate is calcium carbonate made by reacting a slurry of starting materials to form calcium carbonate particles that precipitate from the slurry. Examples of such processes include hydrating high-calcium quicklime and reacting the resulting slurry with carbon dioxide (the “milk of lime” process), and reacting calcium chloride with soda ash and carbon dioxide. The precipitated calcium carbonate particles, when present, may constitute 1 to 100% of the filler particles (ingredient g).

Another optional ingredient is one or more dispersing aids, which wet the surface of the filler particles and help them disperse into the polyether polyol(s). These may also have the effect of reducing viscosity. Among these are, for example, various dispersing agents sold by BYK Chemie under the BYK, DISPERBYK and ANTI-TERRA-U tradenames, and fluorinated surfactants such as FC-4430, FC-4432 and FC-4434 from 3M Corporation. If present at all, such dispersing aids may constitute, for example, up to 2 weight percent, preferably up to 1 weight percent, of the polyol component.

Another useful optional ingredient of the polyol component is a desiccant such as fumed silica, silica gel, aerogel, various zeolites and molecular sieves, and the like. One or more desiccants may constitute up to 5 weight percent, preferably up to 2 weight percent of the polyol component, and may be absent from the polyol component. Dessicants do not count toward the weight of component g).

The polyol component may further include one or more additional isocyanate-reactive compounds, different from ingredients a)-e) of the polyol component. If any such additional isocyanate-reactive compound(s) are present, they preferably constitute no more than 10 percent, more preferably no more than 5 percent and even more preferably no more than 2 percent, of the weight of the polyol component. Examples of such additional isocyanate-reactive compounds include, for example, one or more polyester polyols.

The adhesive of the invention preferably is non-cellular after curing. For that reason, the polyol component preferably contains no more than 0.5% by weight, more preferably no more than 0.1% by weight of organic compounds having a boiling temperature of 80° C. or less, and no more than 0.1% by weight, more preferably no more than 0.05% by weight, of water and/or other chemical blowing agents that produce a gas under the conditions of the curing reaction.

The polyol component in some embodiments contains no more than 10 weight percent, more preferably no more than 5 weight percent, and even more preferably no more than 1 weight percent, of a plasticizer such as a phthalate, terephthalate, mellitate, sebacate, maleate or other ester plasticizer, a sulfonamide plasticizer, a phosphate ester plasticizer, or a polyether di(carboxylate) plasticizer. Such a plasticizer most preferably is absent from the polyol component.

The polyisocyanate component includes at least one organic polyisocyanate.

All or a portion of the organic polyisocyanate may consist of one or more organic polyisocyanates having an isocyanate equivalent weight of up to 350, such as 80 to 250, 80 to 200, or 80 to 180. If a mixture of such polyisocyanate compounds is present, the mixture may have, for example, an average of 2 to 4 or 2.3 to 3.5 isocyanate groups per molecule. Among such polyisocyanate compounds are aromatic polyisocyanates such as m-phenylene diisocyanate, toluene-2, 4-diisocyanate, toluene-2, 6-diisocyanate, naphthylene-1, 5-diisocyanate, methoxyphenyl-2, 4-diisocyanate, diphenylmethane-4,4′-diisocyanate, diphenylmethane-2,4′-diisocyanate, 4,4′-biphenylene diisocyanate, 3,3′-dimethoxy-4,4′-biphenyl diisocyanate, 3,3′-dimethyl-4-4′-biphenyl diisocyanate, 3,3′-dimethyldiphenyl methane-4,4′-diisocyanate, 4,4′,4″-triphenyl methane triisocyanate, polymethylene polyphenylisocyanate (PMDI), toluene-2,4,6-triisocyanate and 4,4′-dimethyldiphenylmethane-2,2′,5,5′-tetraisocyanate. Modified aromatic polyisocyanate s that contain urethane, urea, biuret, carbodiimide, uretoneimine, allophonate or other groups formed by reaction of an isocyanate group are also useful. A preferred aromatic polyisocyanate is MDI or PMDI (or a mixture thereof that is commonly referred to as “polymeric MDI”), and so-called “liquid MDI” products that are mixtures of MDI and MDI derivatives that have biuret, carbodiimide, uretoneimine and/or allophonate linkages.

Further useful polyisocyanate compounds having an isocyanate equivalent weight of up to 350 include one or more aliphatic polyisocyanates. Examples of these include cyclohexane diisocyanate, 1,3- and/or 1,4-bis(isocyanatomethyl)cyclohexane, 1-methyl-cyclohexane-2, 4-diisocyanate, 1-methyl-cyclohexane-2,6-diisocyanate, methylene dicyclohexane diisocyanate, isophorone diisocyanate and hexamethylene diisocyanate.

The polyisocyanate compound(s) having an isocyanate equivalent weight of up to 350 may constitute up to 100% of the weight of the polyisocyanate component. However, it is generally preferred to adjust the isocyanate equivalent weight of the polyisocyanate component to be comparable to (such as from 0.5 to 2 times) the hydroxyl equivalent weight of the polyol component, as this facilitates mixing of roughly equal weights and volumes of the polyol and polyisocyanate components when the adhesive is applied and cured. Accordingly, it is preferred that the polyisocyanate compounds having an isocyanate equivalent weight of up to 350 constitute at most 50%, more preferably at most 30%, of the total weight of the polyisocyanate component.

The polyisocyanate component may contain at least one urethane group-containing, isocyanate-terminated prepolymer having at least 2 isocyanate groups per molecule and an isocyanate equivalent weight of 500 to 3500. The prepolymer may be a reaction product of one or more diisocyanates (preferably one or more aromatic diisocyanates) having a molecular weight of up to 350 with i) at least one 700 to 3000 molecular weight homopolymer of poly(propylene oxide) having a nominal hydroxyl functionality of 2 to 4, ii) at least one 2000 to 8000 molecular weight polyether polyol which is a copolymer of 70 to 99 weight percent propylene oxide and 1 to 30 weight percent ethylene oxide and has a nominal hydroxyl functionality of 2 to 4, or iii) a mixture of i) and ii).

In the case of a mixture of i) and ii), the poly(propylene oxide) used to make the prepolymer may have a molecular weight of 800 to 2000 and more preferably from 800 to 1500, and preferably has a nominal functional of 2 to 3, especially 2. The copolymer of 70 to 99 weight percent propylene oxide and 1 to 30 weight percent ethylene oxide used to make the prepolymer preferably may have a molecular weight of 1000 to 5500 and a nominal functionality of 2 to 3.

The isocyanate-terminated prepolymer my have an isocyanate equivalent weight of 500 to 3500, more preferably 700 to 3000. The equivalent weight for purposes of this invention is calculated by adding the weight of the polyol(s) used to prepare the prepolymer and the weight of polyisocyanate(s) consumed in reaction with the polyol, and dividing by the number of isocyanate groups in the resulting prepolymer. The number of isocyanate groups can be determined using titration methods such as ASTM D2572.

Such a prepolymer may constitute 20 to 90 percent of the weight of the polyisocyanate component. In some embodiments, it constitutes 50 to 90 percent, 60 to 90 percent or 70 to 80 percent of the weight of the polyisocyanate component.

The polyisocyanate used to make the prepolymer can be any of the polyisocyanate compounds identified above, or a mixture of two or more of these. The prepolymer has at least 2, preferably 2 to 4, especially 2 to 3, isocyanate groups per molecule. The isocyanate groups of the prepolymer may be aromatic, aliphatic (including alicyclic), or a mixture of aromatic and aliphatic isocyanate groups. The isocyanate groups on the prepolymer molecules preferably are aromatic.

It is preferred that at least some of the polyisocyanate groups present in the polyisocyanate component are aromatic isocyanate groups. If a mixture of aromatic and aliphatic isocyanate groups is present, it is preferred that at least 50% by number, more preferably at least 75% by number, are aromatic isocyanate groups. In some preferred embodiments, 80 to 98% by number of the isocyanate groups are aromatic and 2 to 20% by number are aliphatic. It is especially preferred that the isocyanate groups of the prepolymer are aromatic, and the isocyanate groups of the polyisocyanate compound(s) having an isocyanate equivalent weight of up to 350 are a mixture of 80 to 98% aromatic isocyanate groups and 2 to 20% aliphatic isocyanate groups.

The polyisocyanate component may contain up to 50% by weight of one or more particulate inorganic fillers as described before. In some embodiments, the polyisocyanate component contains at least 20% by weight of one or more such fillers, and may contain, for example, 20 to 50% or 30 to 40% by weight thereof. Carbon particles such as graphite, activated carbon, carbon black and the like are useful and preferred.

The polyisocyanate component may also contain one or more other additional ingredients, such as those described above with respect to the polyisocyanate compound. As with the polyol component, the polyisocyanate component preferably contains no more than 0.5% by weight, more preferably no more than 0.1% by weight of organic compounds having a boiling temperature of 80° C. or less, and no more than 0.1% by weight, more preferably no more than 0.05% by weight, of water and/or other chemical blowing agents that produce a gas under the conditions of the curing reaction. The polyisocyanate component in some embodiments contains no more than 30 weight percent, more preferably no more than 20 weight percent, of a plasticizer such as a phthalate, terephthalate, mellitate, sebacate, maleate or other ester plasticizer, a sulfonamide plasticizer, a phosphate ester plasticizer, or a polyether di(carboxylate) plasticizer. Such a plasticizer may be absent from the polyisocyanate component.

The polyisocyanate component may contain a coupling agent such as an epoxy silane or aminosilane. The coupling agent may constitute, for example, 0.25 to 5% of the total weight of the polyisocyanate component.

It is generally useful to formulate the polyol component and polyisocyanate component such that when equal volumes of the components are provided, the isocyanate index is 0.5 to 3.6. This facilitates the use of simple mixing ratios of 2:1 to 1:2, especially about 1:1 by volume. It is more preferred to formulate the components so that the isocyanate index is 0.9 to 1.8 or 1.1 to 1.8 when equal volumes of the components are provided. For purposes of this invention, “isocyanate index” is the ratio of the number of isocyanate groups in the polyisocyanate component to the number of isocyanate-reactive groups in the polyol component when the polyol and polyisocyanate components are combined. For purposes of this calculation, a primary amino group is considered as a single isocyanate-reactive group, even though it has two amine hydrogen atoms. A preferred isocyanate index, at a 1:1 volume ratio, is 1.1 to 1.65 or 1.1 to 1.3.

The invention is also a process for bonding two substrates. In general, the polyol component and the isocyanate component are combined to form a reaction mixture. The ratio of these materials may be, for example, such that the isocyanate index is 0.9 to 1.8, 1.1 to 1.8, 1.1 to 1.65 or 1.1 to 1.3. The reaction mixture is formed into a layer between and in contact with the two substrates. An adhesion promoter may be applied to one or both of the substrates prior to contacting the substrate(s) with the adhesive. The adhesive layer is then cured between and in contact with the two substrates to form a layer of cured adhesive bonded to each of the two substrates.

The methods used to mix the isocyanate component with the polyol component, form the adhesive layer and cure the adhesive are, broadly speaking, not critical and a variety of types of apparatus can be used to perform these steps. Thus, the isocyanate component and polyol component can be mixed manually, in various types of batch apparatus, and/or using various sorts of automated metering, mixing and dispensing equipment.

The polyol component and isocyanate component often will react spontaneously upon mixing at room temperature (about 22° C.) and cure without the need to heat the adhesive to a greater temperature. Therefore, in some embodiments, curing is effected by simply mixing the components at a temperature of, for example, 0 to 35° C. and allowing the components to react.

Heat can be applied to the adhesive to obtain a more rapid cure. The polyol and isocyanate components can be heated separately and then mixed and cured, with or without further applied heat. Alternatively, the polyol and isocyanate components can be mixed at a lower temperature such as 0 to 35° C., followed by heating the mixture to a higher cure temperature. The substrate can be heated before applying the adhesive if desired. If an elevated temperature is used in the curing step, such a temperature may be, for example, 36 to 100° C., or 40 to 65° C.

In some embodiments, the adhesive is formulated to provide a latent cure, i.e., a prolonged “open time” during which the adhesive remains flowable and thus allows for manipulation of the adhesive itself and/or a substrate in contact with the adhesive. In some embodiments, the adhesive exhibits an open time of at least 2 minutes, preferably at least 4 minutes, when mixed and cured at room temperature (22±2° C.). For purposes of this invention, open time is measured rheologically by measuring complex viscosity vs. time at room temperature. The polyol and polyisocyanate components are mixed and immediately applied to the plates of a parallel plate rheometer operating in oscillating mode. Plate diameter is 20 mm, plate separation is 1 mm plate. The reactivity measurements are performed at 10 Hz with a constant deformation of 0.062%. The complex viscosity is plotted against the time; and the time at which the slope of the complex viscosity curve has increased by 30% compared to its initial slope is considered to be the open time.

The substrates are not limited. They can be, for example, a metal, a metal alloy, an organic polymer, a lignocellulosic material such as wood, cardboard or paper, a ceramic material, various types of composites, or other materials. Carbon fiber reinforced plastic is a substrate of particular interest. The substrates in some embodiments are vehicular parts or vehicular sub-assemblies that are adhered together with a cured adhesive composition of the invention. The substrates in other embodiments are individual plies that are glued together using the adhesive of the invention to form a multilayer laminate. The substrates in other embodiments are building members.

In preferred embodiments, one or both of the substrates is a low surface energy substrate that has a surface energy of, for example, up to 75 mN/m, especially 30 to 65 nM/m, as measured by applying an alcoholic ISO 8296 testing ink.

An example of a low surface energy substrate is or contains at least 40% by weight polypropylene. By “polypropylene” it is meant a homopolymer of propylene or a copolymer of at least 50% by weight propylene and up to 50% of one or more other monomers. A copolymer may be a random, block and/or graft copolymer. The polypropylene substrate may be filled with one or more fillers such as are described above with regard to the adhesive composition of the invention. If present, such fillers advantageously constitute up to 50 weight-%, especially 20 to 45 weight-%, of the combined weight of polypropylene and fillers. Talc is a filler of particular interest. Alternatively or in addition, the polypropylene substrate may contain reinforcing fibers such as glass, other ceramic, carbon, metal or vegetable fibers. The fibers may constitute up to 50 weight-%, especially 20 to 45 weight-% of the combined weight of polypropylene and fibers. Polypropylene preferably constitutes at least 40% and more preferably at least 50% of a filled and/or fiber-reinforced substrate.

A polypropylene substrate may be flame- or plasma-treated before applying the adhesive of the invention in order to increase its surface energy. Such treatments may be performed to increase the surface energy to, for example, up to 75 mN/m, especially to 30 to 65 nM/m, as measured as described above. Flame treating can be performed using a stoichiometric, oxidative or reductive air-to-fuel ratios.

An advantage of this invention is that good adhesion with the desired cohesive failure can be achieved without the step of applying a primer to the substrate surface either or both of the substrates before the adhesive is applied. Thus, in preferred embodiments of the invention, no primer is applied to at least one of the substrate surfaces prior to applying the adhesive thereto. In especially preferred embodiments, the adhesive is applied to at least one polypropylene substrate without first applying a primer to the surface of such polypropylene substrate. As before, that polypropylene substrate may be filled with filler particles (such as a talc-filled polypropylene substrate) and/or may be fiber-reinforced (such as a glass fiber-reinforced polypropylene substrate), and in each case may be flame- or plasma-treated to increase its surface energy as described before.

The following examples are provided to illustrate the invention, but are not intended to limit the scope thereof. All parts and percentages are by weight unless otherwise indicated. In the following examples:

Polyol A is a nominally trifunctional ethylene oxide-capped poly(propylene oxide) having a molecular weight of about 4800 g/mol and a hydroxyl equivalent weight of about 1600.

Polyol B is a 1400 molecular weight, nominally 7.0 functional poly(propylene oxide) made by alkoxylating a mixture of sucrose and glycerine.

The Polyamine is a 400 molecular weight amine-terminated polypropylene oxide nominally having three terminal primary amine groups per molecule.

Catalyst A is a commercially available dioctyl tin thioglycolate.

Catalyst B is a commercially available dioctyltin dicarboxylate.

Catalyst C is a phenol-blocked 1,8-diazabicyclo[5.4.0]undec-7-ene.

The Filler Mixture is a mixture of a ground CaCO₃ that has a particle size below 45 μm; a precipitated CaCO₃ bearing a stearate coating, in which all particles are smaller than 200 nm; and a calcined kaolin having an average particle size of 3.2 μm, a BET surface area of 8.5 m²/g and a pH of 5.5.

The Dessicant is a mixture of fumed silica and molecular sieves.

The Polyisocyanate is a mixture of 78 parts of a toluene diisocyanate prepolymer having an isocyanate content of 4.4% (available as Desmodur® E15 from Covestro AG); 2 parts of an aliphatic polyisocyanate based on hexamethylene diisocyanate (available as Desmodur® N3400 from Covestro AG); and 18 parts of a particulate carbon black.

The Epoxy Silane is commercially available as Silquest® A187 from Momentive Performance Materials.

Monol 1 is a 750 molecular weight polyether made by polymerizing a 50/50 mixture of propylene oxide and butylene oxide onto dodecyl alcohol.

Monol 2 is a 935 molecular weight polyether made by polymerizing propylene oxide onto a mixture of C12-C15 n-alkanols.

Monol 3 is a 1020 molecular weight polyether made by polymerizing a 50/50 mixture of propylene oxide and ethylene oxide onto 1-butanol.

Monol 4 is a 950 molecular weight polyether made by polymerizing a 50/50 mixture of propylene oxide and butylene oxide onto a mixture of C12-C15 n-alkanols.

### EXAMPLES 1-5 AND COMPARATIVE SAMPLES A-B

Comparative Sample A is made from the following formulation:

TABLE 1

| | |
|---|---|
| Ingredient | Parts By Weight |

Polyol Component

| | |
|---|---|
| Polyol A | 32.1 |
| Polyol B | 3.5 |
| Polyamine | 0.5 |
| Catalyst A | 0.15 |
| Catalyst C | 0.25 |
| Filler Mixture | 58 |
| Dessicant | 5.5 |
| Polyol Component Total Weight | 100 |

Polyisocyanate Component

| | |
|---|---|
| Polyisocyanate | 98 |

The polyol component is made by combining the listed ingredients at room temperature and thoroughly mixing.

Comparative Sample B has the same composition as Comparative Sample A, except 2 parts of the Epoxy Silane are added to the Polyisocyanate Component.

Example 1 has the same composition as Comparative Sample A, except 7 parts of Polyol A are replaced with an equal weight of Monol 1, as indicated in Table 2.

Examples 2-5 have the same composition as Comparative Sample B, except varying amounts of Polyol A are replaced with an equal weight of Monol 1, as indicated in Table 2.

Each of Comparative Samples A and B and Examples 1-5 are evaluated as adhesives for flame-treated talc-filled polypropylene and for flame-treated glass fiber-filled polypropylene. The talc-filled polypropylene is an injection molding grade polypropylene containing 30-40% talc, based on total product weight. The glass-filled polypropylene is a long-glass filled injection molding grade polypropylene containing 30% glass fibers, based on total product weight. In each case, the polypropylene is formed into a 2 mm thick foil and flame treated by passing the foil through an Arcotec Arcogas FTS101D flame treatment unit under conditions of air:propane ratio-25:1; conveyor belt speed-600 mm/s; distance of flame to substrate-60 mm; propane flow rate-2 L/min. This treatment raises the surface energy of the polypropylene samples from 28-30 mN/m to 40-60 mN/m, as determined by applying an alcoholic ISO 8296 testing ink provided by the equipment supplier.

Lap shear specimens are prepared by filling the polyol and polyisocyanate components into separate cartridges that are mounted onto a dual cartridge dispensing gun equipped with a 8-10 mm static mixer unit. The adhesive is dispensed onto one of a pair of flame treated talc-filled polypropylene or flame treated glass fiber-fillled polypropylene test specimens and formed into a 15×25×1.5 mm layer. No primer is applied to the substrates before forming the adhesive layer. The adhesive is cured for 3 days at room temperature (22-24° C.) and ambient humidity. Lap shear strength is then measured according to DIN EN 1465 (2009) using a Zwick 1435 tensile tester equipped with a FHM 860.00.00 or 8606.04.00 mounting device. In each case the adhesive is applied 15-240 minutes after the flame treatment. The samples are evaluated visually for failure mode, with debonding of the adhesive from one or both substrates indicating adhesive failure and tearing of the adhesive layer without separation of the adhesive from the substrate layers indicating cohesive failure.

Results are as indicated in Table 2.

TABLE 2

| | Comp. | Comp. | | | | | |
|---|---|---|---|---|---|---|---|
| Property | A* | B* | Ex. 1 | Ex. 2 | Ex. 3 | Ex. 4 | Ex. 5 |
| Wt. % Polyol A¹ | 32.1 | 32.1 | 25.1 | 28.6 | 25.1 | 21.6 | 18.1 |
| Wt. % Monol 1² | 0 | 0 | 7 | 3.5 | 7 | 10.5 | 15 |
| Wt. % Epoxy Silane³ | 0 | 2 | 0 | 2 | 2 | 2 | 2 |

Talc-Filled PP⁴

| | | | | | | | |
|---|---|---|---|---|---|---|---|
| Lap Shear Str., MPa | 3.71 | 3.26 | 3.23 | 3.10 | 2.57 | 2.24 | 1.96 |
| Failure Mode⁶ | 65CF/ | 95CF/ | 97CF/ | 100CF | 100CF | 100CF | 100CF |
| | 35AF | 5AF | 3AF | | | | |

Glass-Filled PP⁵

| | | | | | | | |
|---|---|---|---|---|---|---|---|
| Lap Shear Str., MPa | 3.53 | 3.63 | 3.49 | 3.20 | 2.84 | 2.33 | 2.02 |
| Failure Mode⁶ | 100AF | 45CF/ | 97CF/ | 100CF | 100CF | 100CF | 100CF |
| | | 55AF | 3AF | | | | |

*Not an example of the invention.
¹Wt.-% Polyol A based on total weight of polyol component.
²Wt.-% Monol 1 based on total weight of polyol component.
³Wt.-% epoxy silane based on total weight of polyisocyanate component.
⁴Results on talc-filled polypropylene substrates.
⁵Results on glass-filled polypropylene substrates.
⁶CF is cohesive failure, AF is adhesive failure. The values indicate the percentage of bond surface area characterized by the respective mode of failure.

Comparative Sample A shows how the control adhesive fails in the undesired adhesive failure mode, particularly on the glass-filled polypropylene substrate. Comparative Sample B demonstrates that adding a coupling agent (epoxy silane) leads to a decrease in the adhesive failure mode in favor of the desired cohesive failure mode. However, the undesired failure mode with the glass-filled polypropylene substrates is close to 50%.

Example 1 demonstrates the effect of replacing a part of Polyol A with a monol. Essentially 100% cohesive failure mode is obtained on even the glass-filled polypropylene substrate, even in the absence of the epoxy silane coupling agent.

Examples 2-5 show 100% cohesive failure on both substrates when the epoxy silane coupling agent is included in the polyisocyanate component. These results are seen across a range of amounts of Monol 1, from 3.5 to 15% by weight of the polyol component. Some loss of lap shear strength is seen, as is to be expected due to the lower average hydroxyl functionality of the isocyanate-reactive materials in the polyol component; this leads to a reduced crosslink density in the cured adhesive.

### EXAMPLES 6 AND 7

Examples 6 and 7 are made and tested in the same manner as previous examples. The adhesive formulations and test results are as indicated in Table 3.

TABLE 3

| | | |
|---|---|---|
| | Ex. 6 | Ex. 7 |
| Ingredient | Parts By Weight | Parts by Weight |

Polyol Component

| | | |
|---|---|---|
| Polyol A | 25.1 | 25.1 |
| Polyol B | 3.5 | 3.5 |
| Monol 2 | 7 | 0 |
| Monol 3 | 0 | 7 |
| Polyamine | 0.5 | 0.5 |
| Catalyst A | 0.15 | 0.15 |
| Catalyst C | 0.25 | 0.25 |
| Filler Mixture | 58 | 58 |
| Dessicant | 5.5 | 5.5 |
| Polyol Component Total Weight | 100 | 100 |

Polyisocyanate Component

| | | |
|---|---|---|
| Polyisocyanate | 98 | 98 |
| Epoxy Silane | 2 | 2 |

Talc-Filled PP¹

| | | |
|---|---|---|
| Lap Shear Str., MPa | 2.51 | 2.64 |
| Failure Mode³ | 100CF | 100CF |

Glass-Filled PP²

| | | |
|---|---|---|
| Lap Shear Str., MPa | 2.69 | 2.59 |
| Failure Mode³ | 100CF | 100CF |

¹Results on talc-filled polypropylene substrates.
²Results on glass-filled polypropylene substrates.
³CF is cohesive failure, AF is adhesive failure. The values indicate the percentage of bond surface area characterized by the respective mode of failure.

As the data in Table 3 shows, the desired cohesive failure mode is seen with both of Examples 6 and 7, even on the glass-filled polypropylene adhesives.

### EXAMPLES 8 AND 9

Examples 8 and 9 are made and tested in the same manner as previous examples. The adhesive formulations and test results are as indicated in Table 4.

TABLE 4

| | | |
|---|---|---|
| | Ex. 8 | Ex. 9 |
| Ingredient | Parts By Weight | Parts by Weight |

Polyol Component

| | | |
|---|---|---|
| Polyol A | 28 | 24.07 |
| Polyol B | 2.5 | 4 |
| Monol 1 | 0 | 7 |
| Monol 4 | 5 | 0 |
| 1,4-butanediol | 0.5 | 0 |
| Catalyst A | 0 | 0.18 |
| Catalyst B | 0.25 | 0 |
| Catalyst C | 0.25 | 0.25 |
| Filler Mixture | 58 | 59 |
| Dessicant | 5.5 | 5.5 |
| Polyol Component Total Weight | 100 | 100 |

Polyisocyanate Component

| | | |
|---|---|---|
| Polyisocyanate | 98 | 98 |
| Epoxy Silane | 2 | 2 |

Talc-Filled PP¹

| | | |
|---|---|---|
| Lap Shear Str., MPa | 2.82 | Not done |
| Failure Mode³ | 100CF | |

Glass-Filled PP²

| | | |
|---|---|---|
| Lap Shear Str., MPa | 3.05 | 2.48 |
| Failure Mode³ | 100CF | 100CF |

¹Results on talc-filled polypropylene substrates.
²Results on glass-filled polypropylene substrates.
³CF is cohesive failure, AF is adhesive failure. The values indicate the percentage of bond surface area characterized by the respective mode of failure.

As the data in Table 4 shows, the desired cohesive failure mode is seen with both of Examples 8 and 9, even on the glass-filled polypropylene adhesives.

1. A two-component polyurethane adhesive composition having a polyol component and an isocyanate component, wherein:
the polyol component comprises:
a) at least 15 weight percent, based on the weight of the polyol component, of one or more polyether polyols each having a nominal hydroxyl functionality of at least 2 and a hydroxyl equivalent weight of 400 to 2000, and each being selected from homopolymers of propylene oxide and copolymers of 70 to 99% by weight propylene oxide and 1 to 30% by weight ethylene oxide, the one or more polyether polyols a) having an average nominal hydroxyl functionality of 2 to 4;
b) 0 to 10 weight percent, based on the weight of the polyol component, of one or more polyether polyols each having a hydroxyl equivalent weight of 100 to 399, the one or more polyether polyols b) having an average nominal functionality of at least 4;
c) 0 to 10 weight percent, based on the weight of the polyol component, of a polyol having a hydroxyl functionality of at least 2 and a hydroxyl equivalent weight of less than 100;
d) 2 to 40 weight percent, based on the weight of the polyol component, of a monol having a molecular weight of 100 to 2000;
e) 0 to 3 parts by weight per 100 parts by weight of a) of at least one compound having at least two primary and/or secondary aliphatic amine groups;
f) a catalytically effective amount of at least one urethane catalyst; and
g) 5 to 60 weight percent, based on the weight of the polyol component, of at least one particulate filler;
and the polyisocyanate component comprises at least one organic polyisocyanate and 0 to 50% by weight, based on the total weight of the polyisocyanate component, of at least one particulate filler.

2. The two-component polyurethane adhesive of claim 1 wherein component d) is prepared by alkoxylating an aliphatic alcohol having the structure A-OH, wherein A represents a hydrocarbyl group.

3. The two-component polyurethane adhesive of claim 1 wherein component d) is represented by the structure A-B—OH, wherein A represents a C4-20 straight-chain aliphatic hydrocarbyl group and B represents a polyether chain.

4. The two-component polyurethane adhesive of claim 1 wherein component d) has a molecular weight of 700 to 1500.

5. The two-component polyurethane adhesive of claim 1 wherein the polyol component contains 4 to 20 weight percent of component d), based on the weight of the polyol component.

6. The two-component polyurethane adhesive of claim 1 wherein the polyol component contains 2 to 10 weight percent of component b), based on the weight of the polyol component.

7. The two-component polyurethane adhesive of any claim 1 wherein the polyol component contains 0.25 to 3 weight percent of component c), based on the weight of the polyol component.

8. A method of bonding two substrates, comprising combining the polyol and polyisocyanate components of the two-component polyurethane adhesive of claim 1 to form an uncured adhesive, forming a layer of the uncured adhesive at a bondline between two substrates, and curing the uncured adhesive layer at the bondline to form a cured adhesive bonded to each of the substrates.

9. The method of claim 8 wherein the isocyanate index is 1.1 to 1.8.

10. A method of bonding a polypropylene substrate to a second substrate, comprising:
I) combining the polyol and polyisocyanate components of the two-component polyurethane adhesive of claim 1 to form an uncured adhesive without previously applying a primer to the polypropylene substrate, forming a layer of the uncured adhesive at a bondline between polypropylene substrate and the second substrates, and II) curing the uncured adhesive layer at the bondline to form a cured adhesive bonded to the polypropylene substrate and the second substrate.

11. The method of claim 10 wherein the polypropylene substrate has a surface energy of no more than 75 mN/m.

12. The method of claim 11 wherein the polypropylene substrate has a surface energy of 30 to 65 mN/m.

13. The method of claim 10 wherein the polypropylene substrate is, prior to step I), flame- or plasma-treated.

14. The method of claim 10 wherein no primer is applied to the polypropylene substrate prior to step I.
